(19) United States
(12) Patent Application Publication
(10) Pub. No.: US 2016/0292300 A1
(43) Pub. Date: Oct. 6, 2016

(54) SYSTEM AND METHOD FOR FAST NETWORK QUERIES

(71) Applicants: Randeep S. Bhatia, Green Brook, NJ (US); Bhawna Gupta, Basking Ridge, NJ (US); Kanthi Sarpatwar, Greenbelt, MD (US); Lloyd Greenwald, Murry Hill, NJ (US)

(72) Inventors: Randeep S. Bhatia, Green Brook, NJ (US); Bhawna Gupta, Basking Ridge, NJ (US); Kanthi Sarpatwar, Greenbelt, MD (US); Lloyd Greenwald, Murry Hill, NJ (US)

(73) Assignees: ALCATEL LUCENT USA INC., Murray Hill, NJ (US); LGS INNOVATION LLC, Herndon, VA (US)

(21) Appl. No.: 14/673,252

(22) Filed: Mar. 30, 2015

(51) Int. Cl. G06F 17/30; H04L 12/44; H04L 12/24

(52) U.S. Cl. CPC G06F 17/30958; H04L 41/145; H04L 12/44; G06F 17/30864; G06F 17/30327

(57) ABSTRACT

A system and method for performing network graph queries on a network graph includes a preprocessing module adapted to generate a data structure from the network graph and to store and dynamically maintain the data structure. The system and method also includes a query module adapted to receive a network query and to generate a query response that answers the network query from the data structure.

### BACKGROUND

A network may include a plurality of nodes and connections forming a network graph representing data and/or information of the network. For example, applications for network graphs may include social networks, computer networks, computer vision, large scale integrations, relational databases, evolutionary biology and the like. Network graph queries are used for extracting information from and/or about, or sending information to, one or more nodes of the network graph. For large networks, answering network graph queries in near real time with known querying systems and methods is typically difficult because the query processing time depends on the size of the network graph.

### SUMMARY

A system for performing network graph queries on a network graph may comprise a preprocessing module configured for generating a data structure from the network graph, and a query module configured for receiving a network query for a query set of nodes of the network graph and for generating a query response to the network query. The data structure may include a plurality of landmark nodes for each node of the network graph, a plurality of landmark distances connecting each node to its respective landmark nodes, a plurality of important nodes that is a subset of the nodes of the network graph and a plurality of paths connecting each important node to each other important node. The query response may be generated by constructing a weighted graph based on the data structure and the network query.

According to an embodiment, the weighted graph may be a gray-black graph constructed using the data structure and the network query.

According to an embodiment, the gray-black graph may include gray edges representing distances based on the landmark distances and black edges representing placeholders.

According to an embodiment, the query module may generate the query response by determining a plurality of forest components in the gray-black graph by deleting one or more of the black edges of the gray-black graph and determining a set of least-cost hook paths for connecting the plurality of forest components using the set of important nodes of the data structure.

According to an embodiment, a computer-implemented method for processing a network graph having a plurality of nodes interconnected by a plurality of edges may comprise generating, using a processor and based on the network graph, a data structure for representing a plurality of landmark nodes for each node of the network graph, a plurality of landmark distances connecting each node to its respective landmark nodes, a plurality of important nodes that is a subset of the nodes of the network graph and a plurality of paths connecting each important node to each other important node. The computer-implemented method may also comprise receiving a network query for a query set of nodes of the network graph and generating, using the processor, a query response to the network query. The query response may be generated by constructing a weighted graph based on the data structure and the network query.

According to an embodiment, the weighted graph of the computer-implemented method may be a gray-black graph including gray edges representing distances based on the landmark distances and black edges representing placeholders.

According to an embodiment, the computer-implemented method may further comprise computing, using the processor, a Minimum Spanning Tree for the gray-black graph, determining a plurality of forest components by deleting one or more of the black edges of the gray-black graph, determining a set of least-cost hook paths for connecting the plurality of forest components using the set of important nodes of the data structure, and generating the query response based on the plurality of forest components and the set of least cost hook paths.

According to an embodiment, the query response may be generated using a Steiner Tree format, Cheapest Tour format, or Minimum Spanning Tree format.

According to an embodiment, a system for performing network graph queries on a network graph may comprise a preprocessing module configured for generating and dynamically maintaining a data structure representing a Minimum Spanning Tree for the network graph, and a query module configured for generating a query response to a network query by outputting the current Minimum Spanning Tree for the network graph. The data structure may comprise a plurality of substructures, each substructure comprising a set of connected components representing at least a portion of the network graph, and a set of edges forming a spanning forest for the set of connected components of the substructure.

According to an embodiment, the preprocessing module may store the set of edges forming the spanning forest of the set of connected components of each substructure of the plurality of substructures of the network graph in a plurality of subforests each of which is arranged in a Euler tree structure.

According to an embodiment, the Euler tree structure may be based on edge levels defining subforests of the spanning forest.

According to an embodiment, the data structure may also comprise a top tree storing the highest level subforest from each substructure, with the top tree of the highest substructure forming an approximate Minimum Spanning Tree for the network graph.

According to an embodiment, the preprocessing module may generate the approximate Minimum Spanning Tree by rounding a weight associated with one or more edges of the network graph.

According to an embodiment, the preprocessing module may dynamically maintain the data structure by adding and deleting edges connecting nodes in the dynamic Minimum Spanning Tree to compensate for changes in the portion of the network graph.

According to an embodiment, a computer-implemented method for processing a network graph having a plurality of nodes interconnected by a plurality of edges may comprise generating, using a processor and based on the network graph, a data structure representing a Minimum Spanning Tree for the network graph, receiving a network query for the network graph, and generating, using the processor, a query response to the network query. The data structure may comprise a plurality of substructures, each substructure comprising a set of connected components representing at least a portion of the network graph and a set of edges forming a spanning forest for the set of connected components of the substructure. The query response may be generated by outputting the current Minimum Spanning Tree represented by the data structure.

According to an embodiment, the computer-implemented method may further comprise dynamically updating the data structure in a memory based on updates to one or more connections between nodes of the network graph.

According to an embodiment, dynamically updating the data structure may further comprise updating the Minimum Spanning Tree for the network graph by adding or deleting one or more edges of the Minimum Spanning Tree based on updates to the one or more connections of the network graph.

According to an embodiment, the computer-implemented method may further comprise storing the set of edges forming the spanning forest of the set of connected components of each substructure of the plurality of substructures of the network graph in a plurality of subforests, each of which is arranged in a Euler tree structure, and adding or deleting one or more edges of the Minimum Spanning Tree based on updates to the one or more connections of the network graph by respectively adding or deleting one or more edges connecting two nodes of one or more substructures in the Euler tree structures.

According to an embodiment, the highest level subforest from each substructure may be stored as a top tree in the data structure, with the top tree of the highest substructure forming an approximate Minimum Spanning Tree for the network graph.

According to an embodiment, adding a new edge connecting two nodes in the Minimum Spanning Tree may comprises identifying if a substructure of the current Minimum Spanning Tree includes both nodes of the new edge in the same connected component, determining if the identified substructure is higher than a substructure of the current Minimum Spanning Tree to which the new edge is being added, and replacing the existing edge with the new edge in the plurality of substructures if the identified substructure is higher than the substructure of the current Minimum Spanning Tree to which the new edge is being added.

According to an embodiment, deleting an existing edge connecting two nodes in the Minimum Spanning Tree may comprise finding a replacement edge in the lowest substructure of the network graph connecting the two connected components in which the two nodes of the existing edge belong, deleting the existing edge from one or more substructures of the plurality of substructures, and inserting the replacement edge in the one or more substructures of the plurality of substructures.

These and other embodiments of will become apparent in light of the following detailed description herein, with reference to the accompanying drawings.

### BRIEF DESCRIPTION OF THE DRAWINGS

FIG. 1 is a schematic diagram of a computerized system according to an embodiment;

FIG. 2 is a flow diagram of an embodiment for preprocessing a network graph in the computerized system of FIG. 1;

FIG. 3 is a pictorial representation of subsets of nodes of the network graph constructed by the computerized system of FIG. 1;

FIG. 4 is a flow diagram of an embodiment for answering a network query of the network graph in the computerized system of FIG. 1;

FIG. 5 is schematic diagram of an embodiment of a data structure of the computerized system of FIG. 1; and

FIG. 6 is a flow diagram of an embodiment for dynamically maintaining a minimum spanning tree in the computerized system of FIG. 1.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

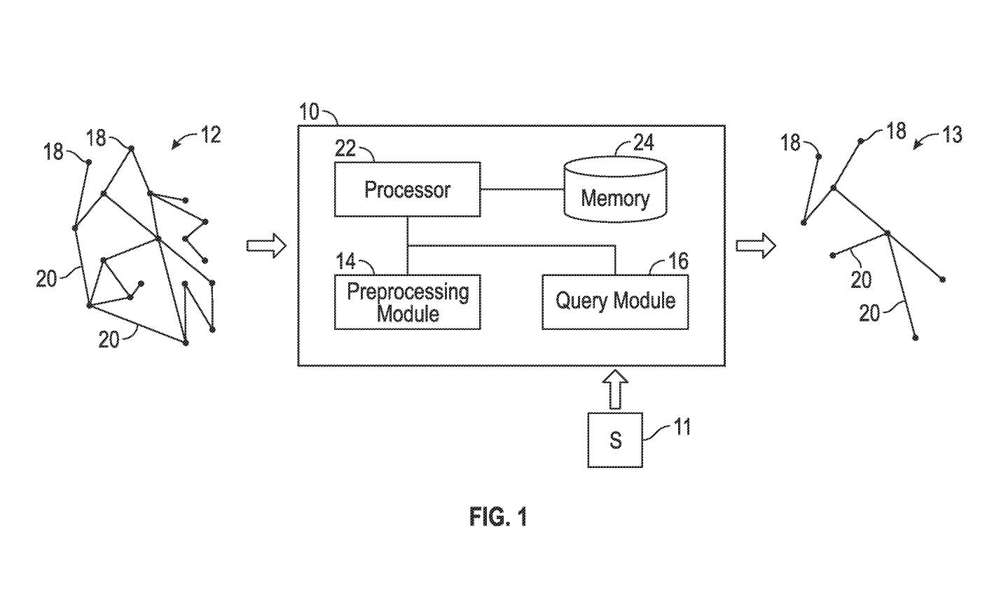

Referring to FIG. 1, a computerized system 10 for answering a network graph query 11 on the network graph 12 by generating a query response 13 answering the network query 11 includes a preprocessing module 14 and a query module 16. The network graph 12 may include a plurality of nodes 18 connected by a plurality of edges 20 and may be static or may be dynamic such that the nodes 18 and/or edges 20 connecting nodes 18 change over time. The network graph 12 may represent, for example, a social network, computer network, computer vision data, large scale integration, relational database, evolutionary biology model or any related network of data. For example, in embodiments, the network graph 12 may be a social network where the users of the social network are the nodes 18 and relationships between the users are represented by the edges 20. The network graph 12 may be a map database where the nodes 18 are addresses and/or intersections and the edges 20 are roads connecting the addresses and/or intersections. Although an exemplary illustration of the network graph 12 is shown in FIG. 1, it should be understood by those skilled in the art that the network graph 12 may, and most likely would, have significantly more nodes 18 and edges 20 than shown in FIG. 1. For example, in social networks, it is not uncommon to have billions of nodes interconnected to each other by an even larger number of edges.

The computerized system 10 includes the necessary electronics, software, memory, storage, databases, firmware, logic/state machines, microprocessors, communication links, and any other input/output interfaces to perform the functions described herein and/or to achieve the results described herein. For example, the computerized system 10 may include one or more processors 22 and memory 24, which may include system memory, including random access memory (RAM) and read-only memory (ROM). Suitable computer program code may be provided to the computerized system 10 for executing numerous functions, including those discussed in connection with the preprocessing module 14 and query module 16. For example, in embodiments, the preprocessing module 14 and query module 16 may be stored in memory 24 of the computerized system 10 and may be executed by the processor 22, as should be understood by those skilled in the art.

The one or more processors 22 may include one or more conventional microprocessors and one or more supplementary co-processors such as math co-processors or the like. The one or more processors 22 may communicate with other networks and/or devices such as servers, other processors, computers, smart phones, cellular telephones, tablets and the like and may receive queries 11 therefrom, as should be understood by those skilled in the art.

The one or more processors 22 may be in communication with memory 24, which may comprise an appropriate combination of magnetic, optical and/or semiconductor memory, and may include, for example, RAM, ROM, flash drive, an optical disc such as a compact disc and/or a hard disk or drive. The one or more processors 22 and the memory 24 may be, for example, located entirely within a single computer or other device; or connected to each other by a communication medium, such as a USB port, serial port cable, a coaxial cable, an Ethernet type cable, a telephone line, a radio frequency transceiver or other similar wireless or wired medium or combination of the foregoing.

The memory 24 may store a variety of data and any other information required by and/or generated by the preprocessing module 14 and query module 16, an operating system, and/or one or more other programs (e.g., computer program code and/or a computer program product) adapted to direct the preprocessing module 14 and query module 16 to perform according to the various embodiments discussed herein. The preprocessing module 14, query module 16 and/or other programs discussed herein may be stored, for example, in a compressed, an uncompiled and/or an encrypted format, and may include computer program code executable by the one or more processors 22. The instructions of the computer program code may be read into a main memory of the one or more processors 22 from the memory 24 or a computer-readable medium other than the memory 24. While execution of sequences of instructions in the program causes the one or more processors 22 to perform the process steps described herein, hard-wired circuitry may be used in place of, or in combination with, software instructions for implementation of the processes of the present invention. Thus, embodiments of the present invention are not limited to any specific combination of hardware and software.

The methods and programs discussed herein may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as providing localization activity recognition. In an embodiment, an application of executable code may be a compilation of many instructions, and may even be distributed over several different code partitions or segments, among different programs, and across several devices.

The term “computer-readable medium” as used herein refers to any medium that provides or participates in providing instructions and/or data to the one or more processors of the computerized system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the one or more processors (or any other processor of a device described herein) for execution. For example, the instructions may initially be stored on a magnetic disk of a remote computer (not shown). The remote computer can load the instructions into its dynamic memory and send the instructions over an Ethernet connection, cable line, telephone line using a modem, wirelessly or over another suitable connection. A communications device local to a computing device can receive the data on the respective communications line and place the data on a system bus for the one or more processors. The system bus carries the data to the main memory, from which the one or more processors 22 retrieve and execute the instructions. The instructions received by main memory may optionally be stored in memory 24 either before or after execution by the one or more processors 22. In addition, instructions may be received via a communication port as electrical, electromagnetic or optical signals, which are exemplary forms of wireless communications or data streams that carry various types of information.

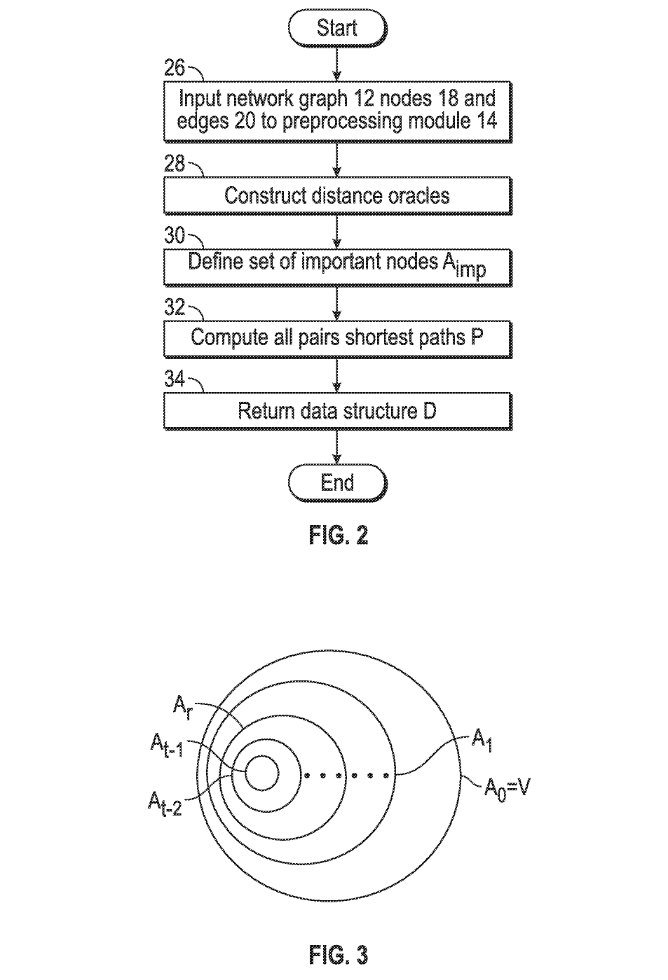

In operation, the preprocessing module 14 of the computerized system 10 preprocesses the network graph 12 in order to answer network graph queries 11. Referring to FIG. 2, at step 26, the preprocessing module 14 receives as an input data the network graph 12 in the form of the nodes 18 and weighted edges 20.

At step 28, the preprocessing module 14 constructs distance oracles on the network graph 12. Various methods for distance oracle construction are known in the art, all of which may be implemented by the preprocessing module 14. For example, the distance oracles may be constructed using the method described in in the article by Mikkel Thorup and Uri Zwick, Approximate Distance Oracles (STOC, pages 183-192, 2001), which is hereby incorporated by reference in its entirety (hereinafter the “TZ method”). Using the TZ method, in one embodiment the preprocessing module 14 randomly and recursively samples nodes 18 from the network graph 12 and constructs a series of randomized node subsets Aₜ₋₁ ⊂Aₜ₋₂ ⊂Aₜ₋₃ ⊂ . . . ⊂A₁ ⊂A₀=V, where V is the set of all nodes 18 within the network graph 12 and t is a tradeoff factor that is greater than or equal to one.

The preprocessing module 14 then constructs, for every node v of the set V of all nodes 18, a set of landmark nodes Bᵥ and computes and stores, as the distance oracles, distances from the node v to each landmark node in Bᵥ. For example, the following exemplary computer pseudo-code may be implemented in the preprocessing module 14 for constructing the set of landmark nodes Bᵥ and the distance oracles:

| | |
|---|---|
| 1 | Initialize A₀ ← V; |
| 2 | forall the i = 1 to t − 1 do |
| 3 | \| Sample vertices of Aᵢ₋₁ with uniform probability n^{-1/t} |
| | \| to obtain Aᵢ; |
| 4 | end |
| 5 | forall the v ε V do |
| 6 | \| forall the i ε [0,t − 1] do |
| 7 | \| \| sᵢ(v) ← argmin_{wεA}_{ᵢ} d(v, w); |
| 8 | \| \| Bᵥⁱ ← {w : w ε Aᵢ₋₁ and d(v, w) ≦ d (v, sᵢ(v) ) }; |
| 9 | \| end |
| 10 | \| Bᵥ = ∪_{iε[0,t-1]} Bᵥⁱ; |
| 11 | \| Compute and store distances from v to every vertex |
| | \|Bᵥ; |
| 12 | end |

where n=|V|; and
d(u,v) is the distance between two nodes u and v.

At step 30, the preprocessing module 14 then defines a set of important nodes kᵢₘₚ defined as:

Aᵢₘₚ=Aᵣ ∪ Aᵣ₊₁ ∪ . . . ∪ Aᵢ₋₁=Aᵣ

where a ceiling for r is set to

$$r = [ \frac{t - 1}{2} ] ,$$

wherein the symbol [value] stands for the ceiling value.

Referring to FIG. 3, the set of important nodes kᵢₘₚ is a subset of the set V of all nodes 18 of the network graph 12, shown in FIG. 1, and includes all of the nodes of the randomized subsets constructed at step 28, shown in FIG. 2, that are smaller than or equal to Aᵣ.

Referring back to FIG. 2, once the preprocessing module 14 has defined the set of important nodes Aᵢₘₚ, the preprocessing module 14 computes the all pairs shortest paths P for the set of nodes 18 within Aᵢₘₚ at step 32. At step 34, the preprocessing module 14 returns a data structure D comprising the shortest path distances from each node v to each landmark node in Bᵥ, as determined above, and comprising all of the paths P. Thus, in addition to the distance oracles constructed using the TZ method, the data structure D includes distances corresponding to every pair of nodes in the set of important nodes Aᵢₘₚ The following exemplary computer pseudo-code may be implemented in the preprocessing module 14 for constructing and outputting the data structure D:

| | |
|---|---|
| | Data: Edge weighted graph G = (V, E) and t > 1 |
| | Result: Distance oracle data structure: [symbol] |
| 1 | Construct TZ method distance oracle on G with parameter t; |
| 2 | $r ← ⌈ \frac{t - 1}{2} ⌉ ;$ |
| 3 | Aᵢₘₚ ← Aᵣ ∪ Aᵣ₊₁ . . . ∪ Aₜ₋₁; |
| 4 | Compute the all pairs shortest paths for the set of vertices Aᵢₘₚ, [symbol] ; |
| 5 | return [symbol] as the shortest paths from each vertex v to vertices in Bᵥ |
| | and all paths [symbol] ; |

where:
G=(V,E) is the network graph 12;
V is the set of all nodes 18 within the network graph 12; and
E is the set of all edges 20, shown in FIG. 1, within the network graph 12.

The preprocessing module 14 may store the data structure D in memory 24, shown in FIG. 1, or in some alternative location, at step 34, to be accessed by the query module 16, shown in FIG. 1, for answering network queries 11, shown in FIG. 1.

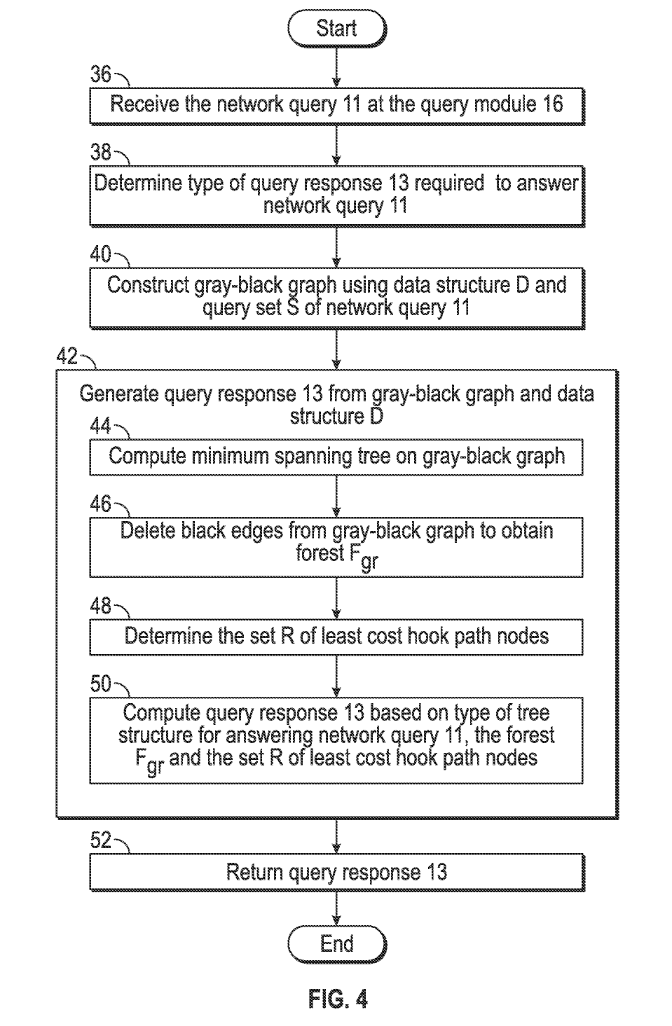

Referring to FIG. 4, a method for answering network queries 11 by the computerized system 10 is shown. At step 36, the query module 16 receives the network query 11 requesting information from or about the network graph 12. The network query 11 may identify the desired information and may include a query set S of nodes within the network graph 12 for or about which the network query 11 concerns. For example, the query set S of nodes may indicate nodes of the graph representing users of a network to whom multicast data is desired to be sent, locations in a map database between which directions are desired, users of a social network between which the shortest number of common connections is desired, or any other set of nodes within the network graph 12 for or about which information represented in the graph is desired.

At step 38, the query module 16 determines a type of query response 13 for answering the network query 11. The type of query response 13 may depend upon information requested about the query set S in the network graph query 11 and may include determining a minimum spanning tree (MST), Steiner tree (ST), cheapest tour (CT) or any similar tree structure or response, as should be understood by those skilled in the art. For example, if the network graph query 11 is a simple distance query requesting the shortest path between a pair of given nodes 18, the query module 16 may determine the query response 13 for satisfying the network query 11 as the CT of the shortest path between the pair of nodes 18. If the network query 11 includes users of a network to whom multicast data is to sent, the query module 16 may determine that the ST interconnecting the nodes of the query set S is the query response 13 for satisfying the network query 11.

In order to determine a MST, ST, or CT, at step 40, the query module 16 constructs a gray-black graph GB using the data structure D stored by the preprocessing module 14, shown in FIG. 1, and the query set S of the network query 11. The gray-black graph GB is a complete weighted graph with the weight function w:S×S→R⁺∪{0}. To construct the gray-black graph GB, the query module 16 may run a known oscillating calculation for every pair of nodes u,v within the query set S for solving the distance oracles of the TZ method for

$$r = [ \frac{t - 1}{2} ]$$

iterations. For example, the following exemplary computer pseudo-code may be implemented in the query module 16 for performing the oscillating calculation:

| | |
|---|---|
| 1 | Initialize x ← u, y ← v; |
| 2 | forall the i ε [0, t − 1] do |
| 3 | \| z ← sᵢ(x); |
| 4 | \| if z ε B_{y} then |
| 5 | \| \|return d(x, z) + d(z, y); |
| 6 | \| end |
| 7 | \| Swap x [symbol] y; |
| 8 | end |

If the calculation terminates within r iterations, there is a 2r−1 approximate distance between the pair of nodes u,v denoted by d_{alg}(u,v) and the query module 16 colors (or designates) the edge 20 between the pair of nodes u,v as a gray edge and sets a weight w(u,v) for the edge 20 between the pair of nodes u,v to d_{alg}(u,v). Alternatively, if the calculation does not terminate within r iterations, the query module 16 colors (or designates) the edge 20 between the pair of nodes u,v as a black edge and sets the weight w(u,v) for the edge 20 between the pair of nodes u,v to two times a maximum of the hook edges mᵤ and mᵥ of u and v, respectively, where the hook edges mᵤ and mᵥ are the paths connecting the nodes u and v to their landmark nodes sᵣ(u) and sᵣ(v), respectively, within the set of nodes Aᵣ=Aᵢₘₚ. The gray-black graph GB may thus be constructed as a set of gray and black edges, where the gray edges may be considered as the real edges having weights within a t−1 factor of the actual distance between corresponding nodes 18 in the original network graph 12 and the black edges may be considered as the placeholders to be further processed by the query module 16 as described below. The following exemplary computer pseudo-code may be implemented in the query module 16 for constructing the gray-black graph:

| | Data: Distance oracle data structure [symbol] , query set S |
|---|---|
| | Result: Gray-Black graph on S |
| 1 | $r ← ⌈ \frac{t - 1}{2} ⌉ ;$ |
| 2 | forall the vertices v ε S do |
| 3 | \| mᵥ ← d(v, sᵣ(v)); |
| 4 | end |
| 5 | Initialize the gray-black graph, [symbol] = (S, E_{GB} = φ); |
| 6 | forall the u, v ε S do |
| 7 | \| Add e = uv to E_{GB}, that is, E_{GB} ← E_{GB} + e; |
| 8 | \| Run the oscillating algorithm on u, v for at most r iterations; |
| 9 | \| if oscillating algorithm terminates before j < r iterations then |
| 10 | \| \| Set w(u, v) = d(u, sⱼ(u)) + d(v, sⱼ(v)) and color e gray; |
| 11 | \| end |
| 12 | \| else |
| 13 | \| \| Set w(u,v) = 2 max(mᵤ, mᵥ) and color e black; |
| 14 | \| end |
| 15 | end |
| 16 | return [symbol] |

where:
E_{GB} is the set of edges in the gray-black graph GB; and
e is an edge with the set of edges E_{GB}.

Once the query module 16 has constructed the gray-black graph GB, at step 42, the query module 16 uses the gray-black graph GB and distances d_{alg}(u,v) stored therein, along with the data structure D comprising the distances between every pair of nodes in the set of important nodes Aᵢₘₚ to generate the query response 13 (e.g., based on a computed MST, CT, or ST as appropriate). To generate the query response 13, the query module 16 may first compute a minimum spanning tree (MST) T on the gray-black graph GB at step 44. Various methods for computing MSTs are known in the art, all of which may be implemented by query module 16. At step 46, the query module 16 then deletes the black edges from the MST T in the gray-black graph GB since only the gray edges are considered to be real edges, as discussed above. The deletion of the black edges results in a forest F_{gr} having components C₁,C₂, . . . , Cₜ comprising nods 18, shown in FIG. 1, connected by gray edges.

In order to provide the query response 13 based on the computed MST, the query module 16 determines a set R of least cost hook path nodes for connecting the components C₁,C₂, . . . , Cₗ to the set of important nodes Aᵢₘₚ. Specifically, for each component Cᵢ, the query module selects a representative node wᵢ with the shortest path to a hook node in the set of important nodes Aᵢₘₚ. The set of representative nodes wᵢ for all components C₁,C₂, . . . , Cₗ is the set R of least cost hook path nodes and the corresponding set of hook nodes in Aᵢₘₚ is H(R). The distances between the nodes wᵢ of the set R of least cost hook path nodes and the respective hook nodes in the set of hook nodes H(R) is the hook path set HP(R).

At step 50, the query module 16 is able to compute the query response 13 from the forest F_{gr} and the set R of least cost hook path nodes since all of the nodes of the set of hook nodes H(R) are within the set of important nodes Aᵢₘₚ stored in the data structure D and since the distances between each pair of nodes in the set of important nodes Aᵢₘₚ is also stored in the data structure D. As should be understood by those skilled in the art, the query response 13 constructed by the query module 16 at step 50 will depend on the type of query response required for answering the network query 11, such as a ST or a CT.

For example, when returning a ST as the query response 13, the query module may compute a ST, denoted by \hat{T}, on the set of hook nodes H(R) and return the query response 13 as T_{alg}=F_{gr}∪\hat{T}∪HP(R), namely, the combination of the forest F_{gr}, the ST \hat{T} on the set of hook nodes H(R) and the distances in the hook path set HP(R). The following exemplary pseudo-code instructions may be implemented as computer code in the query module 16 for generating ST query responses 13:

```
  Data: Modified distance oracle: [symbol]  , Query set: S
  Result: ST on S: T_{alg}
1 Construct the gray-black graph on S, [symbol] [symbol]   , using
2 Compute the minimum spanning tree M_{ST}( [symbol] [symbol]     ) on [symbol] [symbol]    ;
3 Delete all the black edges frpm M_{ST}( [symbol] [symbol]     ) to obtain a forest
  F_{gr}, that has C₁, C₂, . . . , Cₗ as components;
4 Let [symbol]  = {wᵢ : wᵢ ε Cᵢ}, where wᵢ is a vertex with least
  cost hook path in Cᵢ;
5 Compute the Theoreom 3 to compute the ST on [symbol]  ( [symbol]   ). Let
\hat{T} be the corresponding ST ;
6 return T_{alg} \hat{T} U F_{gr} ∪ [symbol] [symbol]    ( [symbol]   );
```

where:

C(MST(G[S]))≧2C(OST(S))−w(e);
where:
   MST(G[S]) is the minimum spanning tree in graph G having nodes S;
   OST(S) is the optimal ST on nodes S, with respect to graph G;
   C(G) is the sum of the edge weights of graph G; and
   e is an edge of maximum weight in MST (G[S]).

At step 50, when returning a CT as the query response 13, the query module may compute an approximate CT, denoted by Ĉ on the nodes of the set of hook nodes H(R) and then return the query response 13 as C_{alg}=Ĉ∪HP(R)²∪F_{gr}², where, for any given subgraph H, H² is the subgraph obtained by duplicating the edges of H. The following exemplary pseudo-code instructions may be implemented as computer code in the query module 16 for generating CT query responses 13:

```
  Data: Modified distance oracle data structure: [symbol] , Query
        set: S
  Result: Tour spanning S: C_{alg}
1 Construct the gray-black graph on S, [symbol] [symbol]   , using
    Algorithm 5;
2 Compute the minimum spanning tree T on [symbol] [symbol]   ;
3 Delete all the black edges from T to obtain a forest F_{gr},
  that has C₁, C₂, . . . , Ci as components;
4 Let [symbol]  = {wᵢ : wᵢ ε Cᵢ}, where wᵢ is a vertex with least
  cost book path in Cᵢ;
5 Using Christofides calculation compute the CT Ĉ on
  the shortest path metric on the vertices [symbol] ( [symbol] );
6 return C_{alg} = Ĉ ∪ F_{gr}² ∪ [symbol] [symbol] ( [symbol] )²;
```

where Christofides calculation includes the following steps:

```
1 Compute the shortest path metric G[S] on S ;
2 Compute a minimum spanning tree T_{S} on G[S];
3 Let O be the set of odd degree vertices in T_{S} and let M_{O}
  be the minimum weight perfect matching, in G[S], on the
  vertices of O ;
4 return T_{S} ∪ M_{O};
```

At step 52, the query module 16 returns the query response 13 that answers the network query 11. Thus, the computerized system 10, shown in FIG. 1, answers the network query 11 with the appropriate ST or CT query response. By generating the ST and CT query responses 13 as discussed above, the computerized system 10, shown in FIG. 1, is able to answer, in near real time, network queries 11 about fundamental properties of massive networks. The query module 16 may be configured to return the query response 13 in response to a trigger, such as when a user submits the query or, alternatively, the query module 16 may be configured to return the query response 13 for a particular network query periodically.

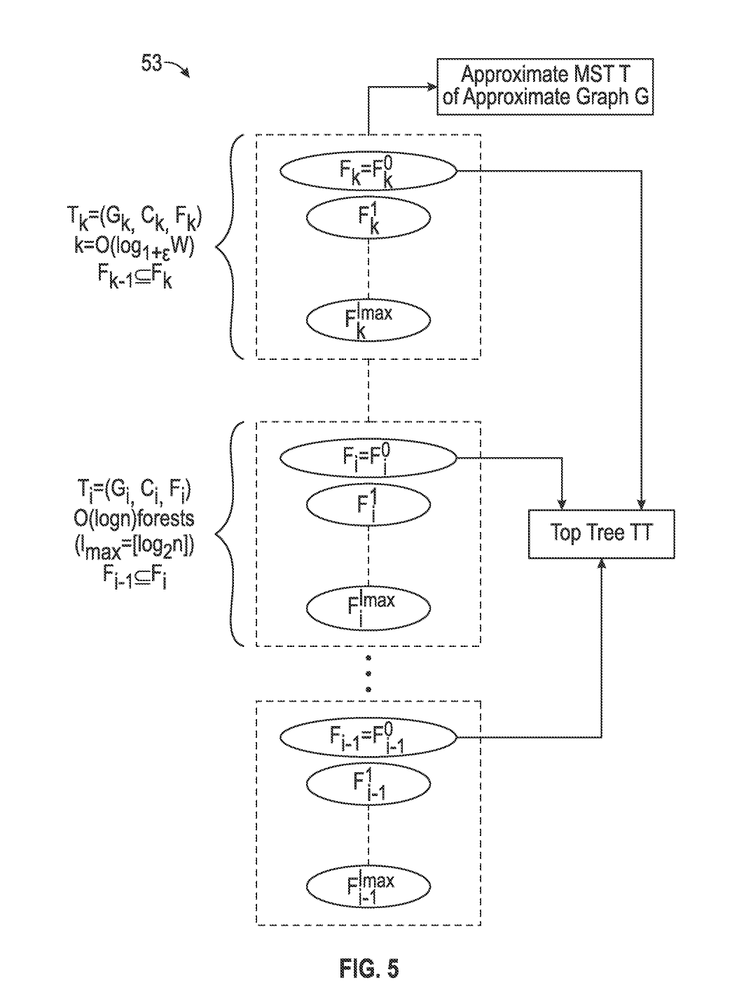

Referring to FIG. 5, the computerized system 10, shown in FIG. 1, may also generate and store a data structure 53 in memory 24, shown in FIG. 1, that is an approximate MST T of an approximate graph G of the network graph 12, shown in FIG. 1, with all edge weights W rounded to the nearest power of (1+ε), where ε>0. In the approximate graph G, all edge weights w(edge) are in the form of (1+ε)ⁱ, where i ranges from 0 to log_{1+ε}, W. For k=log_{1+ε}W+1, a graph Gᵢ, for 1≦i≦k, denotes a subgraph of the approximate graph G formed using edges of weight at most (1+εE)ⁱ⁻¹. For all 1≦i≦k, Cᵢ denotes a set of connected components of Gᵢ, nᵢ denotes the number of connected components in Gᵢ and Fᵢ denotes the set of edges of a spanning forest of the connected components in Cᵢ, with the property that Fᵢ₊₁ includes all the edges in Fᵢ such that Fᵢ⊂Fᵢ₊₁ for all 1≦i≦k−1. The approximate MST T includes substructures Tᵢ for all 1≦i≦k, where each substructure Tᵢ maintains connected components Cᵢ and their spanning forest Fᵢ for graph Gᵢ. It follows that the total weight of edges in Fₖ is the same as that of the approximate MST T of the approximate graph G and, thus, by maintaining the substructures Tᵢ, the computerized system 10, shown in FIG. 1, may maintain the approximate MST T of the network graph 12, shown in FIG. 1.

Within each substructure Tᵢ, the computerized system 10, shown in FIG. 1, dynamically maintains the graph Gᵢ's connected components Cᵢ and spanning forest Fᵢ through edge insertion and/or deletion. In particular, within each substructure Tᵢ, each edge e is assigned an edge level l (e) in the range of 0≦l(e)≦lₘₐₓ=[log₂ n], thus defining the subforests Fᵢ^{j} of Fᵢ, induced by edges of level at least], for each 0≦j≦lₘₐₓ. Within the data structure 53, each subforest Fᵢ^{j} is maintained using Euler Tree data structures, as should be understood by those skilled in the art, and the subforests Fᵢ^{j} satisfy the invariant Fᵢ^{l}^{ₘₐₓ}⊂ . . . Fᵢ¹⊂Fᵢ⁰=Fᵢ. The computerized system 10, shown in FIG. 1, may also maintain the edges of each forest Fᵢ=Fᵢ⁰ in a Top Tree TTᵢ, for all 2≦i≦k. The Top Tree TTᵢ is adapted to handle path queries such that, given any two nodes u and v, the Top Tree TTᵢ may output in time O(log n) an edge of weight (1+ε)ⁱ⁻¹ on a path between u and v in Fᵢ, if such an edge exists.

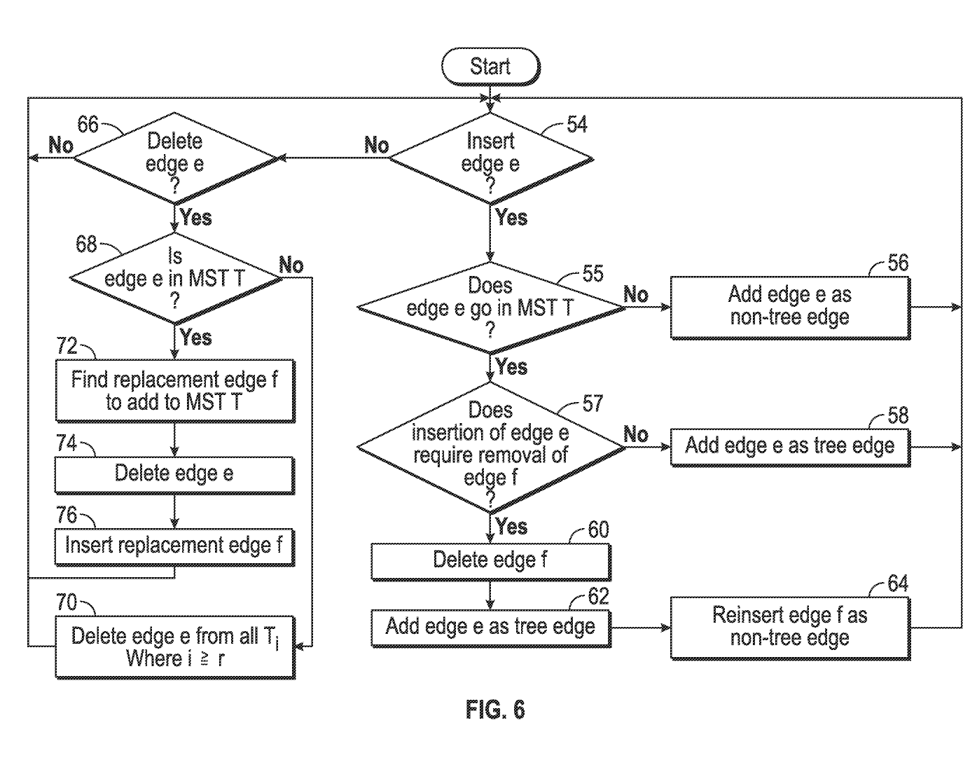

The computerized system 10 dynamically maintains connected components in the approximate MST T by mapping the problem of computing the approximate MST T to the problem of finding connected components in the set of forest components. Referring to FIG. 6, at step 54, the computerized system 10 determines if a new edge e connecting two nodes u and v and having weight w(e)=(1+ε)^{r-1} has been added to the network graph 12, shown in FIG. 1. If a new edge e is being added, at step 55, the computerized system 10 then determines if the new edge e should be part of the approximate MST T of the approximate graph G such that the approximate MST T needs to be updated to include the new edge e. Specifically, the computerized system 10 determines if the new edge e joins two connected components in Cᵣ of the graph Gᵣ, such that the new edge e has to be inserted in all constructions of substructures Tᵢ for i≧r in order to maintain the invariant Fᵢ⊂ Fᵢ₊₁.

If the edge e does not need to be added to the approximate MST T, at step 56, the new edge e is added to the data structure 53, shown in FIG. 5, at level l(e)=0, as a non-tree edge, in all constructions of substructures Tᵢ for i≧r. The new edge e may be inserted, for example, by applying the non-tree edge insertion procedure described in in the article by Jacob Holm, Kristian de Lichtenberg, and Mikkel Thorup, Poly-logarithmic deterministic fully-dynamic algorithms for connectivity, minimum spanning tree, 2-edge, and biconnectivity (JACM, 48(4):723-760, 2001), which is hereby incorporated by reference in its entirety (hereinafter the “HLT method”). The Top Trees TTᵢ are not impacted by the insertion of the non-tree edge.

Alternatively, if the computerized system 10 determines that the new edge e should be added to the approximate MST T at step 55, the computerized system 10 determines if the insertion of new edge e requires the removal of an existing edge f connecting the nodes u and v of weight w(f)>w(e) at step 57. If insertion of the edge e does not require removal of existing edge f, the computerized system 10 adds the new edge e to the data structure 53, shown in FIG. 5, as a tree edge at step 58. For example, the computerized system 10 may insert the new edge e to each construction of substructures Tᵢ for i≧r according to the insertion procedure of the HLT method. The new edge e is inserted at level at level l(e)=0 and all of the subforests Fᵢ⁰ are updated. New edge e is also added to the Top Trees TTᵢ for max{2, r} ≦i≦k.

If, at step 57, the computerized system 10 determines that insertion of the new edge e connecting the nodes u and v requires removal of existing edge f from the approximate MST T of the approximate graph G, at step 60, the computerized system 10 deletes the existing edge f from the data structure 53, shown in FIG. 5, before inserting new edge e. For example, just before insertion of the new edge e, the computerized system 10 may define r′>r as the smallest value at which nodes u and v are in the same connected component of Fᵣ⁰, for the construction of substructures T_{r′} in which case the existing edge f of weight w(f)=(1+ε)^{r′-1} on the path from nodes u and v in the approximate MST T exists in the forest F_{r′}=F_{r′}⁰. The existing edge f may be found by applying the path query for nodes u and v to the Top Tree TT_{r′} and, by the invariant Fᵢ⊂Fᵢ₊₁, it follows that the edge f is in all forests Fₛ for s≧r′. The computerized system 10 may, thus, delete the existing edge f from the approximate graph G at step 60 using the delete procedure of the HLT method on every construction of substructure Tₛ, as well as delete the existing edge f from all of the Top Trees TTₛ. Once existing edge f has been deleted nodes u and v belong to different connected components in all forests Fₛ for 1≦s≦k.

At step 62, the computerized system 10 may then add the new edge e as a tree edge in the data structure 53, shown in FIG. 5. For example, the computerized system 10 may insert the new edge e as a tree edge in the approximate graph G in substantially the same manner as in step 58 according to the insertion procedure of the HLT method.

At step 64, the computerized system 10 may then reinserts the edge f into the data structure 53, shown in FIG. 5, as a non-tree edge. For example, the computerized system 10 may reinsert the edge f by applying the non-tree edge insertion procedure of the HLT method in substantially the same manner as discussed in connection with step 56. Thus, the computerized system 10 may advantageously update the approximate graph G through edge insertion of both tree and non-tree edges of the approximate MST T.

If, at step 54, a new edge has not been added, the computerized system 10 then considers whether edge e connecting two nodes u and v and having weight w(e)=(1+ε)^{r-1} has been deleted from network graph 12, shown in FIG. 1, at step 66. If edge e has not been deleted, no further action is required by the computerized system 10. If edge e has been deleted, thereby requiring the data structure 53, shown in FIG. 5, to be updated, the computerized system 10 determines if the edge e is a tree edge in the approximate MST T at step 68. If the edge e is not a tree edge in the approximate MST T, at step 70, the computerized system 10 deletes the edge e from all constructions of substructures Tᵢ where i≧r, for example, using the non-tree edge deletion procedure of the HLT method. The Top Trees TTᵢ are not impacted by the deletion of the non-tree edge.

Alternatively, if the edge e is a tree edge in the approximate MST T, at step 72, the computerized system 10 finds a replacement existing edge f of weight w(f)≧w(e) to add to the approximate MST T. The existing edge f for replacing edge e may be found, for example, by applying the replacement procedure of the HLT method at every construction of substructures Tᵢ where i≧r, for increasing values of i until the existing edge f is found by the computerized system 10. Finding the replacement edge f for edge e does not impact the Top Trees TTᵢ since, although some edges may change levels, all edges in Fᵢ remain included in forest Fᵢ⁰, at level 0, and the Top Trees TTᵢ are only maintained for these edges. When selecting the replacement edge f, for a particular substructure Tᵢ the only relevant edges are the non-tree edges of weights w=(1+ε)ⁱ⁻¹, since all lower weight edges would have been considered earlier when selecting the edge e for the approximate MST T. Thus, the computerized system 10 may find the replacement edge f, if such an edge exists, in, for example, substructure T. At step 74, the computerized system 10 then deletes the edge e from all constructions of substructures Tᵢ where i≧r, including the Top Trees TTᵢ. For example, the computerized system 10 may delete edge e using the delete procedure of the HLT method discussed in connection with step 60. At step 76, the computerized system 10 inserts the replacement edge f, if such an edge exists, as a tree edge of the forest Fᵢ in all constructions of substructures Tᵢ where i≧s. For example, the computerized system may insert the replacement edge f using the insertion procedure of the HLT method discussed in connection with step 62. The level of replacement edge f within each substructure Tᵢ remains unchanged. The computerized system 10 may also insert the replacement edge f in all Top Trees TTᵢ for all i≧max {s,2}. Thus, the computerized system 10 may advantageously update the approximate graph G through edge deletion of both tree and non-tree edges of the approximate MST T.

The computerized system 10 may dynamically maintain the approximate MST T by continuing to add and delete edges, as necessary, according to steps 54 through 76, while continuing to maintain the invariant Fᵢ⊂Fᵢ₊₁ for all 1≦i≦k−1. The computerized system 10 advantageously improves maintenance of an approximate MST T on a fully dynamic network graph 12 by accommodating for edge additions and deletions in the approximate graph G and in the approximate MST T of the network graph 12. For example, by maintaining a (1+ε) approximate MST (for an arbitrarily small constant ε>1) rather than the optimal MST, the computerized system 10 may provide an amortized running time O(log³ n) as compared to known amortized running times that are O(log⁴ n) per operation. This improvement is achieved by jointly maintaining connected components at logn different sets of edge weights and by quickly identifying and removing heavy edges in the cycle formed after edge insertion according to the method shown in FIG. 6.

As discussed above, the Top Trees TTᵢ are adapted to handle path queries and may maintain additional information used by the computerized system 10 for this purpose. For example, in addition to maintaining dynamic forests under the edge insertion and deletion operations, as discussed above, the Top Trees may also support an Expose operation in O(logn) amortized time that, for any two different vertices u and v, that are within the same forest Fᵢ in the approximate MST T, returns a cluster of the Top Tree TTᵢ for the operation Expose(u,v) within which the path from u to v in the approximate MST T is contained. This provides the computerized system 10 with constant time access to path information maintained in the Top Tree TTᵢ for the u to v path of the approximate MST T. The Top Tree TTᵢ maintains a pointer p(C)=e on the path from u to v in the approximate MST T, where:
e is an edge of weight (1+ε)ⁱ⁻¹ on the path; and
C is a path cluster with boundary nodes u and v.
If no such edge e exists, the computerized system 10 sets p(C)=null.

Each path cluster C in the Top Tree TTᵢ is associated with at most two special vertices of the graph called the boundary nodes and may be used by the computerized system 10 to maintain path values for these nodes. Updates to the Top Tree TTᵢ may be implemented by the computerized system 10 as a sequence of two basic operations on the clusters C called Merge and Split that allow the computerized system 10 to maintain the path cluster information P(C).

For example, C=Merge(A,B) returns a new cluster C with children A and B by combining Top Tree components T_{A} and T_{B} in the a Top Tree with root C. The computerized system 10 sets p(C)=null if either C is not a path cluster or both p(A)=p(B)=null. Otherwise, the computerized system 10 sets p(C)=e, where e is the edge pointed to by either the non-null pointer p(A) or p(B).

For the operation Split(C), the computerized system 10 splits a root cluster C of Top Tree T, having children A and B, into two Top Tree components T_{A} and T_{B} and deletes C. For the Split operation, the computerized system 10 does not need to change the pointers of the child clusters.

Both the Merge and Split operations take constant time and, therefore, all operations for dynamically maintaining the approximate MST T, including dynamically maintaining the Top Tree TT, under edge insertion and deletion and querying for an edge of weight (1+ε)ⁱ⁻¹ on the path from nodes u to v can be performed by the computerized system 10 in O(logn) amortized time. Additionally, by dynamically maintaining the approximate MST T, the computerized system 10 may avoid having to compute the MST for a particular set of nodes 18, shown in FIG. 1, for which the approximate MST T is being maintained.

The computerized system 10, shown in FIG. 1, also advantageously provides query responses with approximation guarantees that are an order of magnitude better than the existing solutions and with querying times on the order of O(ts²). The computerized system 10, shown in FIG. 1, is able to answer, in near real time, network queries 11, shown in FIG. 1, about fundamental properties of massive networks. The computerized system 10, shown in FIG. 1, may be implemented for network applications in a variety of domains including social networks, computer networking, computer vision, very large scale integration, relational databases, evolutionary biology and the like. This enables users to analyze their social, data or computer network properties in near real time and may, therefore, provide for better planning, troubleshooting and management of networks. The computerized system 10, shown in FIG. 1, may also allow network administrators to observe network changes in near real time, thereby enhancing the efficiency of the network, and may provide enhanced opportunities for revenue as changes in social relationships may also be analyzed in near real time. Additionally, the query module 16 may advantageously be configured to automatically generate one or more query responses to one or more queries on a periodic basis.

The computerized system 10, shown in FIG. 1, may be particularly, applicable for networks with billions of nodes 18 and edges 20, where classic query systems and methods cannot respond to online queries in real time. For example, query processing times for many classical query methods depend on the size of the entire graph and, therefore, answering even simple distance queries may take hours or days to complete and may not be acceptable in a realistic setting. Other classical approaches attempt to preprocess the network data so that the query running time depends only on the query size, as opposed to the network size. However, these classical approaches require space quadratic in the network size and, therefore, are not feasible for large networks. The computerized system 10, shown in FIG. 1, overcomes these deficiencies of the classical methods and, advantageously, improves upon the TZ method by providing better approximation guarantees using the same space-time complexity.

For example, the computerized system 10, shown in FIG. 1, advantageously provides fast query processing time for ST and CT queries in static networks while significantly reducing approximation error as compared to known solutions. For example, the computerized system 10, shown in FIG. 1, may provide better results having approximation guarantees for ST and CT queries of 3t+2 and 2.5t+0.5, respectively, for trade-off parameter t 1, thₐₙ known methods, such as the TZ method discussed above, which provides approximation guarantees of 4t−2 and 3t−1.5, respectively, while using the same space-time complexity O(tk²) for both preprocessing and query modules.

The computerized system 10, shown in FIG. 1, advantageously provides improvements in approximation guarantees and query processing times for ST and CT queries 11, shown in FIG. 1, in static network graphs 12, shown in FIG. 1, while maintaining the same space-time complexity for preprocessing and query execution as the state of the art. In systems and methods providing approximate results, any improvements in the approximation guarantees can significantly reduce the quality of the results. Additionally, in real time queries on large amount of data it is typically desirable to improve the run time or processing time of the solution so that the solution appears more responsive and interactive. The computerized system 10, shown in FIG. 1, advantageously improves ST and CT approximation guarantees over existing solutions while maintaining the same space-time complexity for preprocessing and query execution. The computerized system 10, shown in FIG. 1, also provides improvements for dynamic graphs by improving the run time for dynamic MST computation by an order of magnitude over existing solutions.

Although this invention has been shown and described with respect to the detailed embodiments thereof, it will be understood by those skilled in the art that various changes in form and detail thereof may be made without departing from the spirit and the scope of the invention.

What is claimed is:

1. A system for performing network graph queries on a network graph, the system comprising:
a preprocessing module configured for generating a data structure from the network graph, wherein the data structure includes a plurality of landmark nodes for each node of the network graph, a plurality of landmark distances connecting each node to its respective landmark nodes, a plurality of important nodes that is a subset of the nodes of the network graph and a plurality of paths connecting each important node to each other important node; and
a query module configured for receiving a network query for a query set of nodes of the network graph and for generating a query response to the network query, the query response being generated by constructing a weighted graph based on the data structure and the network query.

2. The system according to claim 1, wherein the weighted graph is a gray-black graph constructed using the data structure and the network query.

3. The system according to claim 2, wherein the gray-black graph includes gray edges representing distances based on the landmark distances and black edges representing placeholders.

4. The system according to claim 3, wherein the query module generates the query response by determining a plurality of forest components in the gray-black graph by deleting one or more of the black edges of the gray-black graph and determining a set of least-cost hook paths for connecting the plurality of forest components using the set of important nodes of the data structure.

5. A computer-implemented method for processing a network graph having a plurality of nodes interconnected by a plurality of edges, the method comprising:
generating, using a processor and based on the network graph, a data structure for representing a plurality of landmark nodes for each node of the network graph, a plurality of landmark distances connecting each node to its respective landmark nodes, a plurality of important nodes that is a subset of the nodes of the network graph and a plurality of paths connecting each important node to each other important node;
receiving a network query for a query set of nodes of the network graph; and
generating, using the processor, a query response to the network query, the query response being generated by constructing a weighted graph based on the data structure and the network query.

6. The computer-implemented method according to claim 5, wherein the weighted graph is a gray-black graph including gray edges representing distances based on the landmark distances and black edges representing placeholders.

7. The computer-implemented method according to claim 6, further comprising:
computing, using the processor, a Minimum Spanning Tree for the gray-black graph;
determining a plurality of forest components by deleting one or more of the black edges of the gray-black graph;
determining a set of least-cost hook paths for connecting the plurality of forest components using the set of important nodes of the data structure; and
generating the query response based on the plurality of forest components and the set of least cost hook paths.

8. The computer-implemented method according to claim 5, wherein the query response is generated using a Steiner Tree format, Cheapest Tour format, or Minimum Spanning Tree format.

9. A system for performing network graph queries on a network graph, the system comprising:
a preprocessing module configured for generating and dynamically maintaining a data structure representing a Minimum Spanning Tree for the network graph, the data structure comprising a plurality of substructures, each substructure comprising:
a set of connected components representing at least a portion of the network graph; and
a set of edges forming a spanning forest for the set of connected components of the substructure; and
a query module configured for generating a query response to a network query by outputting the current Minimum Spanning Tree for the network graph.

10. The system according to claim 9, wherein the preprocessing module stores the set of edges forming the spanning forest of the set of connected components of each substructure of the plurality of substructures of the network graph in a plurality of subforests each of which is arranged in a Euler tree structure.

11. The system according to claim 10, wherein the Euler tree structure is based on edge levels defining subforests of the spanning forest.

12. The system according to claim 10, wherein the data structure comprises a top tree storing the highest level subforest from each substructure, with the top tree of the highest substructure forming an approximate Minimum Spanning Tree for the network graph.

13. The system according to claim 12, wherein the approximate Minimum Spanning Tree is generated by the preprocessing module by rounding a weight associated with one or more edges of the network graph.

14. The system according to claim 9, wherein the preprocessing module dynamically maintains the data structure by adding and deleting edges connecting nodes in the dynamic Minimum Spanning Tree to compensate for changes in the portion of the network graph.

15. A computer-implemented method for processing a network graph having a plurality of nodes interconnected by a plurality of edges, the method comprising:
generating, using a processor and based on the network graph, a data structure representing a Minimum Spanning Tree for the network graph, the data structure comprising a plurality of substructures, each substructure comprising:
a set of connected components representing at least a portion of the network graph; and
a set of edges forming a spanning forest for the set of connected components of the substructure; and
receiving a network query for the network graph; and
generating, using the processor, a query response to the network query, the query response being generated by outputting the current Minimum Spanning Tree represented by the data structure.

16. The computer-implemented method according to claim 15, further comprising dynamically updating the data structure in a memory based on updates to one or more connections between nodes of the network graph.

17. The computer-implemented method according to claim 16, wherein dynamically updating the data structure further comprising updating the Minimum Spanning Tree for the network graph by adding or deleting one or more edges of the Minimum Spanning Tree based on updates to the one or more connections of the network graph.

18. The computer-implemented method according to claim 16, further comprising:
storing the set of edges forming the spanning forest of the set of connected components of each substructure of the plurality of substructures of the network graph in a plurality of subforests, each of which is arranged in a Euler tree structure; and
adding or deleting one or more edges of the Minimum Spanning Tree based on updates to the one or more connections of the network graph by respectively adding or deleting one or more edges connecting two nodes of one or more substructures in the Euler tree structures.

19. The computer-implemented method according to claim 18, wherein the highest level subforest from each substructure is stored as a top tree in the data structure, with the top tree of the highest substructure forming an approximate Minimum Spanning Tree for the network graph.

20. The computer-implemented method according to claim 18, wherein adding a new edge connecting two nodes in the Minimum Spanning Tree comprises:
identifying if a substructure of the current Minimum Spanning Tree includes both nodes of the new edge in the same connected component;
determining if the identified substructure is higher than a substructure of the current Minimum Spanning Tree to which the new edge is being added; and
replacing the existing edge with the new edge in the plurality of substructures if the identified substructure is higher than the substructure of the current Minimum Spanning Tree to which the new edge is being added.

21. The method according to claim 18, wherein deleting an existing edge connecting two nodes in the Minimum Spanning Tree comprises:
finding a replacement edge in the lowest substructure of the network graph connecting the two connected components in which the two nodes of the existing edge belong;
deleting the existing edge from one or more substructures of the plurality of substructures; and
inserting the replacement edge in the one or more substructures of the plurality of substructures.
